(19) United States
(12) Patent Application Publication
(10) Pub. No.: US 2004/0009265 A1
(43) Pub. Date: Jan. 15, 2004

(54) Sealed system to dispense oleoresin capsicum and other hot spices into wet or dry batter

(76) Inventors: Ruben E. Alexander, Atlanta, GA (US); Gracie C. Alexander, Atlanta, GA (US)

Correspondence Address: Ruben E. Alexander, 113 Summer Drive, Atlanta, GA, 30328, US

(21) Appl. No.: 10/190,565

(22) Filed: Jul. 9, 2002

(51) Int. Cl. A23G 3/00

(52) U.S. Cl. 426/94

(57) ABSTRACT

The present invention provides a commercial process for dispensing oleoresin capsicum or other hot spices into wet, dry batter and sauces. The process produces a superior spicy product and includes the steps of: providing a quantity of spicy meats, fish, vegetables and sauces; providing a conveying means to dispense oleoresin capsicum or other hot spices in in batter or sauces through the various steps of the present invention; convey oleoresin capsicum or other hot spices from drum to weight cells; weight cells through a clear viol to spray bar, which is dispersed into a mixer; this system disperses dehydrated oleoresin capsicum or other hot spices; this system is fully sealed to protect the environment and surrounding areas from fumes disbursed from the oleoresin capsicum or hot spices. These systems can be fully automated.

### BACKGROUND OF THE INVENTION

1. Field of the Invention

The present invention relates generally to sealed oleoresin capsicum dispensing system, and more specifically to commercial processes for preparing a spicy product. The process begins with a raw food product, and ends with a quality spicy battered product, or quality spicy sauces. A variety of food products or sauces can be a quality spicy product by this invention including chicken, fish, potatoes and a variety of other meats, vegetables and sauces.

2. Description of Related Art

Consumers are constantly searching for better tasting spicy foods and sauces that holds it heat units during frying or baking. For example, commercial food processing companies provide fast food restaurants and the like with large quantities of several types of spicy products and sauces. Customers demand the tastiest spicy products available.

Other comestibles such as meat, fish, vegetables, also are commonly marinated overnight in hot peppers or other hot spices, then coated with batter. Sauces are prepared with other hot spices, but during the cooking process, loses most or all the heat units. During the cooking process of meats, fish and vegetables, also lose their heat units.

There is thus constant innovation in the field of food processing to find just the right mix of dispensing oleoresin capsicum or other hot spices, liquid or dehydrated to develop a superior food product that will please the end, consumers in taste.

In the search for a superior spicy food or sauces, the present invention provides an end food product that, upon frying or baking has full flavor of a spicy product.

Several subaltern methods of dispensing ingredients are known. For example:

| Inventors | U.S. Pat./Pub. Number (s): |
|---|---|
| Lee et al | U.S. Pat. No. 4,375,484 |
| Doster et al. | U.S. Pat. No. 4,283,430 |
| Fehr, Jr. et al. | U.S. Pat. No. 3,649,304 |
| Benson et al. | U.S. Pat. No. 3,477,851 |
| Laughlin et al. | U.S. Pat. No. 5,858,440 |
| Melvej | U.S. Pat. No. 5,431,944 |
| Graf et al. | U.S. Pat. No. 5,536,513 |
| DeFigueiredo | U.S. Pat. No. 5,009,903 |
| Nothum, Sr. et al. | 2002/002034 |
| | (Publication) |

### A. DESCRIPTION OF THE SIGNIFICANT PRIOR ART

U.S. Pat. No. 3,477,851 to Benson at al. Teaches a process for preparing a filled food product. Dough ingredients are mixed, cooked, and cut to length. The filler ingredients are mixed, measured by a metering pump, and injected into the cooked dough. The process is highly automated. While this system could be used for most filled food products, it does not seem suitable for battering foods; nor is it sufficiently sealed for oleoresin capsicum or other hot spices.

U.S. Pat. No. 3,649,304 to Fehr Jr. et al. Teaches a process for producing a ready-to cook batter which is suitable to be sold commercially in a premixed form. In this process, batter is first mixed, then transferred through piping and deposited into a container. Part of the process is sealed, but this process does not lend itself well to handling hot spices or oleoresin capsicum.

U.S. Pat. No. 4,283,430 to Doster et al. Teaches a process for preparing center filled food products. In this process, batter is mixed, partially baked, and transferred to a forming belt. Filling is injected into the dough while the forming process is completed. The filling is metered by a cylinder, but most of the process is open to the air and is, therefore, not suitable for handling oleoresin capsicum or other hot spices.

U.S. Pat. No. 6,352,730 B1 to Zimmerman et al. Teaches a suspension for adding a controlled quantity of ingredient to a food product. In this process, the suspension is pumped from a feed tank to a manifold containing a series of nozzles. A conveyor presents the product to be coated beneath the nozzles. This process appears most useful for coating potato chips with flavoring ingredients.

U.S. patent application Publication No. 2002/0020343 A1 to Nothum Sr. et al. teaches a convertible batter mixer and applicator machine. The batter may be mixed in discrete batches or it may be converted for use in a continuous fashion. An open mesh wire conveyors passes the food product through the batter in order to coat it. A viscometer is used to help control the process to maintain the batter at the desired viscosity. The mixing and battering process is not sealed.

Given the state of the process of dispensing oleoresin capsicum or other hot spices comestible art as described above, there is a continuing need for a new and useful processes for dispensing oleoresin capsicum or other hot spices for preparing a quality spicy products, safer and more cost efficient than prior art techniques.

Therefore, it can be seen that a need yet exists for a safe and environmental friendly system to dispense oleoresin capsicum or other hot spices.

### BRIEF SUMMARY OF THE INVENTION

Briefly described, in its preferred form, the present invention provides a method for dispensing hot spice into wet or dry batter, in a environmental safe dispensing system, to be deep fried or baked. The present process preferably comprises the following steps:

(a) providing a quantity of spicy food product;

(b) providing a conveying means to convey the spicy food product through the various steps of the present invention;

(c) dispensing hot spice or oleoresin capsicum into batter, wet or dry on a Tandem line;

(d) the heat units will not lose it strength, while deep frying or baking the product

(e) interjecting the hot spice or oleoresin capsicum;

(f) wet or dry battering;

(g) dispensing hot spices or oleoresin capsicum on fully cooked or raw product;

A fully cooked or raw food product at ambient temperature is the preferred initial food product for the present process. That is, for meat, poultry and fish, the most desirable way to do spicy food products, is to use this dispensing process, although it can be accomplished by, interjecting the hot spice or oleoresin capsicum directly into the wet or dry batter. For vegetables, fruits and the like, a fresh product is most desirable.

The most desirable and cost effective way of processing a superior spicy product, is to use the dispensary process. Using this process, it will be assured you get a quality product, same amount of heat units in every batch of product processed, using a wet or dry batter, a large amount of product can be produced. Hot spice or oleoresin capsicum can be introduced into a small or large amount of wet or dry batter.

This process will assure your product retain the heat units, after deep frying or baking. Dispensing the hot spice or oleoresin capsicum into the batter. The hot spice or oleoresin capsicum will be evenly distributed in wet or dry batter, each batch will be the same at all times. The hot spice or oleoresin capsicum is weighed before entering the batter through weight cells, scales, or other means. The hot spice or oleoresin capsicum are weighed and double checked again through a holding viol to make sure the right amount are being disbursed. Containers are air tight, the hot spice or oleoresin capsicum cannot become airborne. This process is environmental friendly.

This system of dispersing oleoresin capsicum or other hot spices offers the advantage of sterility, purity, dispensability, and convenience, thus reducing cost of production, while insuring uniformity, and reducing quality problems.

### BRIEF DESCRIPTION OF THE FIGURES

FIG. 1 is flow diagram of the preferred embodiment of the present invention using a single mixer used for light breading.

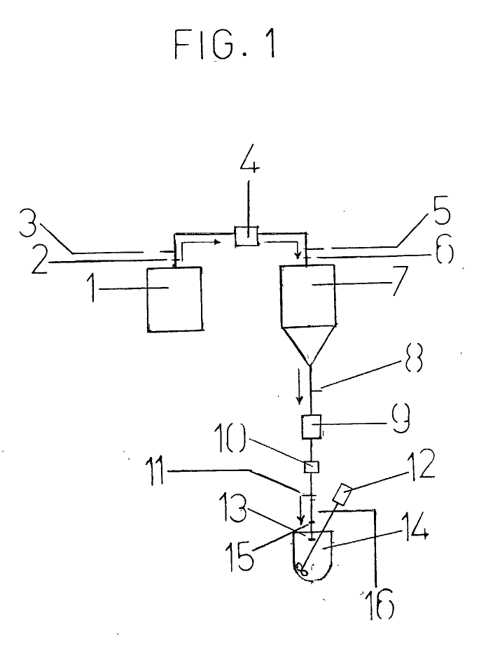

FIG. 2 is a flow diagram of the preferred embodiment of the present invention including a sealed mixer for dehydrating.

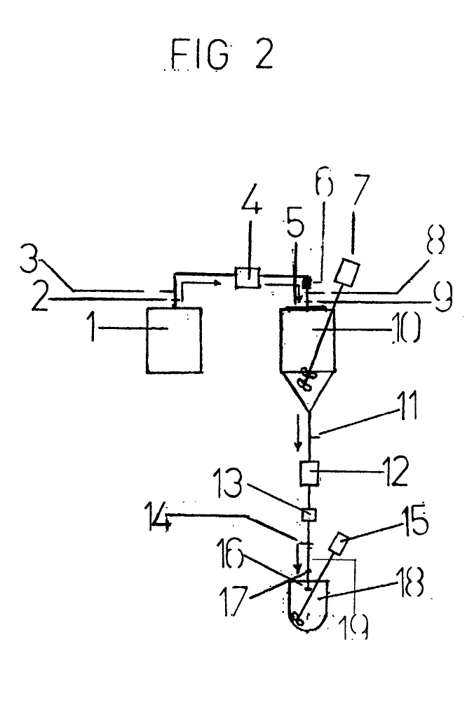

FIG. 3 is a flow diagram of the present invention illustrating the preferred dispensing system for heavy breading.

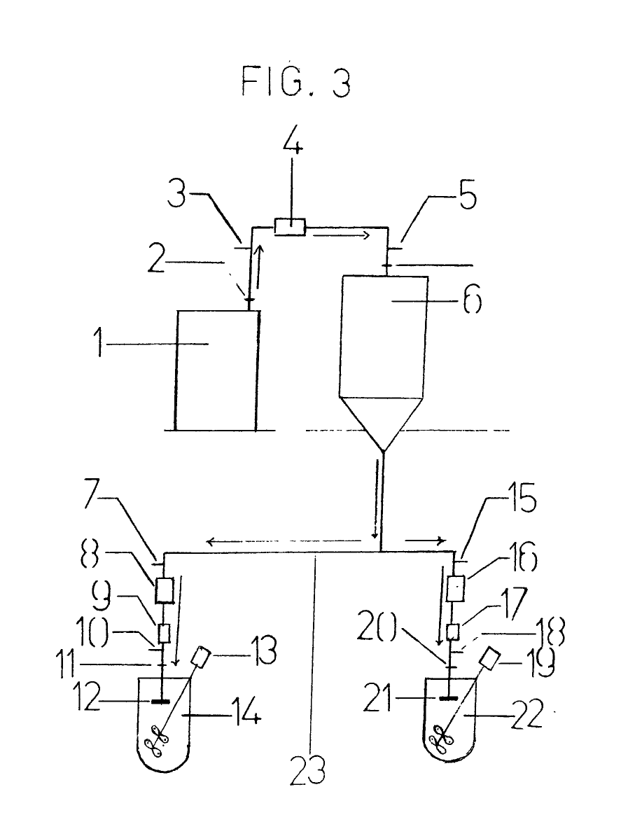

FIG. 4 is a flow diagram of dispensing oleoresin capsicum on a smaller sealed line.

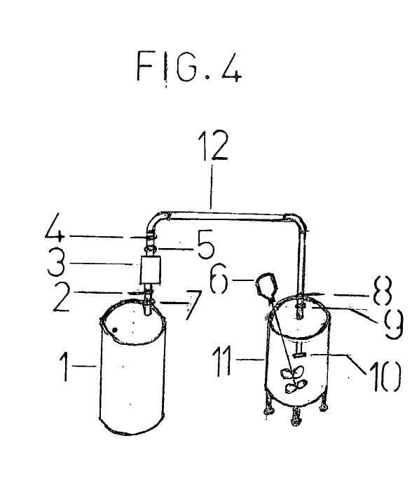

### DETAILED DESCRIPTION OF A PREFERRED EMBODIMENT

Referring now in detail to the drawings figures, wherein like reference numerals represent like parts though out the several drawings. The present process preferably comprises the following steps:

(a) oleoresin capsicum can be purchased in fifty five (55) gallons drum 1;

(b) quick change coupling or tri-clamp or equal 2;

(c) shut off valve 3 is used while changing drum 1 to avoid drainage;

(d) suction pump 4 is used to transfer oleoresin capsicum to holding 10;

(e) opening 5 for carrier for dehydrating oleoresin capsicum;

(f) weight cells 6 or equal can be used to disperse the right amount of oleoresin capsicum;

(g) mixer 7 is used while dispensing 16 oleoresin capsicum;

(h) shut off valve 8 is used while cleaning drum;

(i) quick change coupling 9 or tri-clamp or equal for changing drum if needed;

(j) holding drum 10 for oleoresin capsicum or dehydrated capsicum;

(k) shut off valve 11 used here if any thing need to be changed below;

(l) weight cells 12 or equal to be used for dispensing the right amount of oleoresin capsicum or hot spices;

(m) ounce gauge 13 used to in sure the right amount of oleoresin capsicum or hot spice be dispensed;

(n) shut off valve 14 to be used when oleoresin capsicum is not needed;

(o) mixer 15 used to mix batter or sauce with oleoresin capsicum or hot spice;

(p) spray bar 16 is used for oleoresin capsicum;

(q) quick change coupling 17 or tri-clamp or equal to used to remove mixer 15 or spray bar 16;

(r) mixer drum 18;

(s) three inch pipes are used in these drawings, although pipe size my vary;

Dispensing oleoresin capsicum on a smaller sealed line.

(a) oleoresin capsicum drum 1;

(b) shut off valve 2 used while changing oleoresin capsicum drum 1;

(c) metering pump 3 used for dispensing the right amount of oleoresin capsicum;

(d) shut off valve 4 used if metering pump 3 need to be replaced;

(e) tri clamp 5 used for taking metering pump 3 out;

(f) mixer 6 used to mix batter or sauce with oleoresin capsicum or hot spice;

(g) tri clamp 5 or equal used for changing oleoresin capsicum drum 1;

(h) shut off valve 8 to be used when cleaning mixer 6;

(i) tri clamp 9 or equal to be used when cleaning mixer 6;

(j) spray bar 10 to used when dispensing oleoresin capsicum;

(k) mixer bowl 11;

(l) pipe 12 may vary;

While the invention has been disclosed in preferred forms, it will be apparent to those skilled in the art that many modifications, additions, and deletions can be made therein without departing from the spirit and scope of the invention as set forth in the following claims.

### DISPENSING OLEORESIN CAPSICUM into ONE WET BATTER FIG. #1

1. Oleoresin Capsicum Drum 55 Gallons

2. Quick Change Coupling or Equal

3. Shut Off Valve

4. Suction Pump

5. Shut Off Valve

6. Quick Change Coupling or Equal

7. Oleoresin Capsicum Dispensing Tank

8. Shut Off Valve

9. Weight Cells

10. Ounce Gauge

11. Shut Off Valve

12. Mixer

13. Spray Bar

14. Mixer

15. Quick Change Coupling or Equal

16. Piping

### DEHYDRATING AND DISPENSERING SYSTEM FIG. #2

1. Oleoresin Capsicum Drum

2. Quick Change Coupling or Equal

3. Shut Off Valve

4. Suction Pumps

5. Opening for Carrier

6. Weight Cells or equals

7. Mixer

8. Shut Off Valve

9. Quick Change Coupling or Equal

10. Carrier Drum

11. Shut Off Valve

12. Weight Cells

13. Ounce Gauge

14. Shut Off Valve

15. Mixer

16. Spray Bar

17. Quick Change Coupling or Equal

18. Mixing Drum

19. Piping

### DISPENSING OLEORESIN CAPSICUM INTO WET BATTER FIG.#3

1. Oleoresin Capsicum Drum 55 Gallons

2. Quick Change Coupling or Equal

3. Shut Off Valve

4. Suction Pump

5. Shut Off Valve

6. Oleoresin Capsicum Tank 55 Gallons

7. Shut Off Valve

8. Weight Cells or Other

9. Ounce Gage

10. Shut Off Valve

11. Quick Change Coupling or Equal

12. Spray Bar

13. Mixer

14. Mixer Bowl

15. Shut Off Valve

16. Weight Cells or Other

17. Ounce Gage

18. Shut Off Valve

19. Mixer

20. Quick Change Coupling or Equal

21. Spray Bar

22. Mixer Bowl

23. Piping

### DISPENSING OLEORESIN CAPSICUM ON A SMALLER LINE FIG.#4

1. Oleoresin Capsicum Drum

2. Shut off Valve

3. Metering Pump

4. Shut off Valve

5. Tri-Clamp or Equal

6. Mixer

7. Tri-Clamp or Equal

8. Shut off Valve

9. Tri-Clamp or Equal

10. Spray Bar

11. Mixer Bowl

12. Piping

What is claimed is:

1. System to dispense oleoresin capsicum and other hot spices into wet or dry batter comprising the steps of:
(a) providing a quantity of food products;
(b) dispensing hot spice or oleoresin capsicum;
(c) retaining the strength of heat units;
(d) using a suction pump for interjecting the oleoresin capsicum or hot spice from the 55 gallon drum to the dispensing drum;
(e) into wet or dry batter using weight cells or metering pump for dehydrated oleoresin capsicum;
(f) dispensing hot spice or oleoresin capsicum for a fully cooked or raw product;

2. The process of preparing spicy battered foods according to claim 1, comprising the further step of dispensing the oleoresin capsicum or hot spice into wet or dry batter.

3. The process of preparing spicy battered foods according to claim 2, retaining the strength of the heat units.
(g) providing a wet or dry batter;
(h) steps to prepare spicy battered foods
(i) three steps system, oleoresin capsicum or hot spice may be dispensed into the thin and thicker wet batter, or dispensed into one or the other, thin or thicker wet batter.
(j) two step system, oleoresin capsicum or hot spice may be dispensed into the wet batter, not the dry dusting;
(k) one step system, the oleoresin capsicum or hot spice will be dispensed in the wet batter only;

4. system to disperse oleoresin capsicum or hot spice on a Tandem line;

5. these dispensing system can be used in dispensing oleoresin capsicum and dehydrated oleoresin capsicum and other hot spices into sauces and various other products on the Tandem line, but not restricted to Tandem lines only.

6. These dispensing system is not restricted to the cat walk only, it may be used in in various locations;

7. These dispensing system is fully sealed;

8. dispensing oleoresin capsicum from 55 gallon drum through metering pump directly into mixer;

9. these system is not restricted to a 55 gallon drum for oleoresin capsicum, any size drum or container may be used with this system.

10. these systems can be fully automated;
